(19) United States
(12) Patent Application Publication
(10) Pub. No.: US 2021/0317393 A1
(43) Pub. Date: Oct. 14, 2021

(54) APPLIANCES AND CONTAINERS FOR PREPARING A BEVERAGE IN A TRANSPARENT CHAMBER

(71) Applicant: ANHEUSER-BUSCH INBEV S.A., Brussels (BE)

(72) Inventors: Daniel Peirsman, Bornem (BE); Stijn Vandekerckhove, Sterrebeek (BE); Jerome Pellaud, New Rochelle, NY (US); Nathaniel Davis, New Rochelle, NY (US)

(21) Appl. No.: 17/354,863

(22) Filed: Jun. 22, 2021

Related U.S. Application Data
(63) Continuation-in-part of application No. 15/955,257, filed on Apr. 17, 2018.
Application No. 15/955,257 is a division of application No. 15/054,196, filed on Feb. 26, 2016, now abandoned.
(60) Provisional application No. 62/126,218, filed on Feb. 27, 2015.

(51) Int. Cl. C12C 12/00; B67D 3/00; B67D 1/00; B67D 1/08; B65D 81/26; B65D 85/804; A47J 31/60

(52) U.S. Cl. CPC C12C 12/00; B67D 3/0012; B67D 3/0019; B67D 3/0067; B67D 1/0021; B67D 1/07; B67D 1/0804; B67D 1/0872; B65D 81/266; B65D 85/8043; A47J 31/60; B67D 1/0078

(57) ABSTRACT

The present invention describes appliances for preparing and dispensing beverages, such as beers, featuring a transparent window that allows a user of the appliance to view the beverage in a chamber of the appliance as that beverage is being prepared. The chamber in which the beverage is prepared can be either an integral part of the appliance or a disposable chamber that can be removed and replaced with a new disposable chamber after one or more servings of a. beverage has been prepared in the disposable chamber. The appliances can have methods for cleaning the chamber, or the chamber can be self-cleaning. If the chamber for preparing the beverage is a disposable container, it may come with a concentrated beverage already prepackaged in the container, and the casing of the container can prevent oxygen and light from penetrating the container and affecting the concentrated beverage contained within.

### CROSS REFERENCE TO RELATED APPLICATION

This application is a continuation-in-part of U.S. patent application Ser. No. 15/955,257, filed Apr. 17, 2018, which is a divisional of U.S. patent application Ser. No. 15/054,196, filed Feb. 2, 2016, which claims the benefit under 35 U.S.C. 119(e) of U.S. Provisional Patent Application No. 62/126,218, filed Feb. 27, 2015, all of which are hereby incorporated by reference in their entirety.

### TECHNICAL FIELD

The present invention pertains to appliances and containers for preparing a beverage in a transparent chamber, allowing users to view the beverage in the chamber while the beverage is being prepared and before it is dispensed. More particularly, the present invention is directed to: a) appliances for preparing a beverage comprising a housing, a liquid source, and a beverage dispenser, where at least one portion of the exterior of the appliance is transparent, and the at least one transparent portion of the exterior of the appliance comprises a transparent wall of a chamber for preparing a beverage; and b) disposable containers for preparing a beverage that comprise an exterior casing and a first chamber containing a concentrated beverage, where a first portion of the exterior casing is transparent. The chamber for preparing a beverage in the appliances may be either an integral portion of the housing or alternatively a disposal chamber that can be removed from the appliance and replaced after preparing one or more servings of a beverage.

### BACKGROUND OF THE INVENTION

In recent years, a diverse array of appliances for preparing and dispensing beverages have been developed and marketed. Some of these methods and appliances allow users to prepare beverages, such as coffee or tea, in single-serving quantities on demand. These appliances vary wildly in their complexity, size, and expense, and can be purchased for use at home or in the office.

Many of these appliances allow users to prepare hot, brewed beverages such as coffee or tea. Commonly, these appliances function by heating water to near-boiling temperatures, and then passing that heated water over coffee powder or tea leaves. In certain appliances, the coffee powder or tea leaves are contained in pre-packaged containers designed specially for use in that appliance. After the coffee or tea is brewed and the beverage dispensed from the machine, a user of the appliance can add ingredients such as milk, cream, sugar, or honey to the beverage.

However, these existing appliances suffer from many drawbacks. They are commonly limited to specific types of hot beverages, such as coffee or tea, as described above. And recently, the beverage world has seen a proliferation of extremely popular custom-flavored beverages—such as microbrewed beers that expertly blend a complex array of flavors and ingredients, spirits infused with fruits and spices, and sports drinks that offer both taste and nutrition, and zero-calorie soft drinks that meld new ingredients with traditional flavors. Existing appliances for preparing beverages are simply incapable of meeting the needs and desires for preparing these customizable beverages. For example, there is no existing appliance that would allow a user to create, on-demand, a single serving of a beer.

Furthermore, a significant portion of the appeal of such beverages is not merely generated by their taste, but by their visual appearance as well. The desirability of a cup of tea or a mug of coffee is greatly enhanced when that beverage is prepared, for example, in a French press, allowing one to watch the flavors seep out of the coffee grounds or tea leaves and infuse the hot water to prepare the beverage. Similarly, watching an amber-colored beer poured from a tap to fill a pint glass is significantly more visually appealing than merely having that beer delivered in an opaque container.

Because of the important role that this visual presentation plays in the preparation of a beverage, there remains a need for beverage-dispensing appliances that allow users of the appliance to view their beverage while it is being prepared, so that this visual component is not lost. However, the manufacture and design of such appliances presents challenges. For example, an appliance with a chamber that allows a user to view a serving of a beer being prepared must ensure that the chamber remains clean and hygienic each time a new serving of a beer is dispensed. The appliances and containers of the present invention are directed towards meeting these needs and challenges.

### SUMMARY OF THE INVENTION

The present invention is directed, in certain embodiments, to appliances for preparing a beverage, comprising a housing, at least one source of liquid, and a dispenser for dispensing a beverage, wherein at least one portion of the exterior of the appliance is transparent, and the at least one transparent portion of the exterior of the appliance comprises a transparent wall of a chamber for preparing the beverage.

In certain embodiments of the invention, the transparent portion of the exterior of the appliance is rectangular. In other embodiments of the invention, the transparent portion is circular.

In certain embodiments of the invention, the chamber for preparing the beverage is coupled to the dispenser for dispensing the beverage.

In certain embodiments of the invention, the at least one source of liquid is a source of a carbonated liquid. In certain other embodiments of the invention, the at least one source of liquid is a source of a still liquid.

In certain embodiments of the invention, the chamber for preparing the beverage is an integral portion of the housing. In certain further embodiments of the invention, the chamber for preparing the beverage is coupled to a mixing chamber for mixing the liquid and a concentrated beverage.

In certain embodiments of the invention, the liquid and a concentrated beverage are mixed in the chamber for preparing the beverage. In certain further embodiments of the invention, the chamber for preparing the beverage comprises a first chamber and a second chamber, and the first chamber and second chamber are divided by a partition. In still further embodiments of the invention, the partition is opaque, the liquid and the concentrated beverage are mixed in the first chamber, and the transparent portion is a transparent wall of the second chamber.

In certain embodiments of the invention, the chamber for preparing the beverage is self-cleaning. In further embodiments of the invention, the chamber comprises a biocidal coating. In still further embodiments of the invention, the biocidal coating comprises a metal, such as copper or silver.

In certain embodiments of the invention, the appliance for preparing a beverage further comprises at least one device for cleaning the chamber for preparing the beverage. In further embodiments of the invention, the at least one device for cleaning the chamber cleans the chamber by heating, flushing or sterilizing the chamber. In still further embodiments of the invention, the at least one device for cleaning the chamber cleans the chamber by sterilizing the chamber with ultraviolet light.

In certain embodiments of the invention, the transparent wall of the chamber for preparing the beverage is comprised of a material selected from the group consisting of glass, plastics, and polymers.

In certain embodiments of the invention, the chamber for preparing the beverage and the dispenser are oriented on a single aspect of the appliance.

In certain embodiments of the invention, the chamber for preparing the beverage is a disposable chamber that can be removed from the appliance and replaced with a new disposable chamber. In certain further embodiments of the invention, the disposable chamber comprises a concentrated beverage.

In certain embodiments of the invention, the appliance for preparing a beverage further comprises a puncturing device for perforating the exterior of the disposable chamber to allow the liquid to enter the disposable chamber.

In certain embodiments of the invention, the disposable chamber is capable of preparing a single serving of a beverage. In other embodiments of the invention, the disposable chamber is capable of preparing multiple servings of a beverage.

The present invention is directed, in certain embodiments, to disposable containers for preparing a beverage, comprising an exterior casing and a first chamber containing a concentrated beverage, wherein at least a first portion of the exterior casing of the disposable container is transparent. In certain further embodiments of the invention, the disposable container further comprises a second chamber, wherein the first chamber and the second chamber are divided by an opaque partition, and the first, transparent, portion of the exterior casing is a wall of the second chamber. In still further embodiments of the invention, the disposable container further comprises a third chamber that contains at least one flavor.

In certain embodiments of the invention, the concentrated beverage is a solid or liquid concentrated beverage. In certain further embodiments of the invention, the concentrated beverage is a carbonated concentrated beverage.

In certain embodiments of the invention, at least a second portion of the exterior casing is a permeable portion. In certain further embodiments of the invention, the second portion of the exterior casing is permeable to liquid.

In certain embodiments of the invention, the first chamber also contains an oxygen scavenger.

In certain embodiments of the invention, the exterior casing resists the transmission of light into the disposable container.

In certain embodiments of the invention, the exterior casing is impermeable to gas. In certain further embodiments of the invention, the exterior casing is impermeable to oxygen.

In certain embodiments of the invention, the disposable container further comprises a removable opaque material that covers the first transparent portion of the exterior casing. In certain further embodiments of the invention, the removable opaque material is a film or a foil.

### BRIEF DESCRIPTION OF THE DRAWINGS

FIG. 1 is a perspective view of an appliance for preparing a beverage, with a transparent portion of the exterior of the appliance that allows a user to view the interior of a chamber in the appliance for preparing a beverage.

FIG. 2 is a front view of the appliance for preparing a beverage depicted in FIG. 1.

FIG. 3 is a perspective view of a recyclable pod according to Example 2;

FIG. 4 is a perspective view of a recyclable pod according to Example 2 with aluminum foil covering the transparent window.

FIG. 5 is a perspective view of recyclable box-shaped capsule according to Example 3.

FIG. 6 is a perspective view of a recyclable box-shaped capsule according to Example 3 with a recyclable plastic film covering the transparent window.

### DETAILED DESCRIPTION OF THE INVENTION

As discussed above, the present invention is directed to appliances and containers for preparing a beverage in a transparent chamber. As those of ordinary skill in the art will recognize, such appliances and containers allow users to view the beverage in the chamber while the beverage is being prepared and before it is dispensed.

Those of ordinary skill in the art will recognize that the various embodiments of the invention can be used to prepare a wide variety of beverages. For example, the beverage prepared by the appliances and containers of the present invention may be any beverage selected from the group consisting of a beer (including ales and lagers), a malt-based beverage, a cider, a wine, a spirit, a mixed drink, a soft drink, a juice, a coffee, or a tea. In some preferred embodiments of the invention, the beverage is an alcoholic or non-alcoholic beer, such as an alcoholic or non-alcoholic ale or an alcoholic or non-alcoholic lager. In certain other preferred embodiments of the invention, the beverage is a malt-based beverage other than a beer.

For the purposes of the present invention, the term “beer” is defined as a beverage produced by the brewing and fermentation of a starch source in water using yeast. Suitable starch sources include, but are not limited to, grains such as barley, wheat, corn, rice, sorghum, and millet. Other starch sources, such as cassava, sugarcane, and potato, can also be used as a starch source to produce a beer. Similarly, various strains of yeast may be used to ferment a “beer,” including but not limited to ale yeast strains (“top-fermenting” yeast) and lager yeast strains (“bottom-fermenting yeast”).

For the purposes of the present invention, the term “beer” includes but is not limited to a particular subset of beverages defined as a “beer” under a particular state's laws, regulations, or standards. For example, the German Reinheitsgebot states that a beverage having ingredients other than water, barley-malt, and hops cannot be considered a “beer”—but for the purposes of the present invention, the term “beer” has no such ingredient restrictions. Similarly, for the purposes of the present invention, the term “beer” does not import or imply a restriction on the alcoholic content of a beverage.

In some preferred embodiments of the present invention, the beverage is prepared by an appliance. In these preferred embodiments, the appliance comprises: a) a housing (H) that contains at least some of the components of the appliance; b) at least one source of liquid; and c) a dispenser for dispensing the beverage prepared by the appliance. In these preferred embodiments, at least one portion of the exterior of the appliance is transparent, and this at least one transparent portion of the exterior of the appliance is a transparent portion of a wall of a chamber for preparing the beverage. This transparent “window” allows a user of the appliance to view the beverage while it is being prepared within the appliance.

In some embodiments of the invention, the chamber for preparing the beverage, including the at least one transparent window, may be an integral portion of the housing of the appliance. In other embodiments of the invention, the chamber for preparing the beverage (including the transparent window) is not an integral portion of the housing of the appliance, but can be removed from the appliance. In some embodiments, the removable chamber is a reusable chamber that can be removed, cleaned, and then re-installed in the appliance. In other embodiments, the removable chamber is a disposable chamber that is removed from the appliance, disposed of, and replaced with a new disposable chamber.

The at least one transparent viewing window can be located at various positions on the appliance. In some preferred embodiments of the invention, the transparent window is located in the front of the appliance and directly faces the user operating the appliance. However, in other embodiments of the invention, the window can be located in other locations, for example, on the top of the appliance, or on the side of the appliance. In some embodiments of the invention, there may be multiple transparent windows located in multiple places on the appliance—for example, a first transparent window on the top of the appliance and a second transparent window on the front of the appliance.

The transparent window of the beverage preparation chamber may be shaped differently in various embodiments of the invention. The transparent window may be a circle, an oval, a square, a hexagon, or another polygonal shape. The transparent window may be a three-dimensional structure—for example, in some exemplary embodiments, the beverage preparation chamber is spherical, and the transparent window may be a portion of that sphere, such as a hemisphere. In other embodiments, the beverage preparation chamber is a box, and the transparent window is two or more walls of that box. Other shapes for the transparent window will be known to those skilled in the art.

In some embodiments of the invention, the transparent portion may be an entire wall of the chamber for preparing the beverage, but in other embodiments, the transparent window may be only a portion of a wall of the beverage preparation chamber. In certain embodiments, portions (or the entirety) of multiple walls of the chamber for preparing the beverage are transparent windows.

In some embodiments of the invention, the transparent window for viewing into the chamber for preparing the beverage is composed of transparent glass. In other embodiments of the invention, the transparent window is composed of a transparent plastic. In other embodiments of the invention, the transparent window is composed of a transparent polymer.

As discussed above, in some embodiments of the invention, the chamber for preparing the beverage is a reusable chamber that can be removed, cleaned, and then re-installed in the appliance. However, in some preferred embodiments of the invention (including both embodiments where the chamber is an integral portion of the appliance's housing and embodiments where the chamber is removable from the appliance), the chamber is a self-cleaning chamber.

The self-cleaning chamber can utilize a variety of different methods (or combinations of methods) to keep the chamber for preparing the beverage clean and sanitary. In some of these embodiments of the invention, the self-cleaning chamber comprises an antimicrobial film or coating over the transparent viewing window. The anti-microbial film or coating can be composed of, for example, a polymer having a quaternary amine functional group.

In some embodiments of the invention, the self-cleaning chamber comprises a biocidal coating on the walls of the container. In some embodiments, the biocidal coating comprises a metal having anti-bacterial properties, such as copper, silver, gold, titanium dioxide, or gallium. For example, the coating may incorporate particles, such as nanoparticles, of silver or copper. In some embodiments of the invention, the chamber may be coated with a non-stick or non-wetting coating, such as polytetrafluoroethylene (PTFE), which prevents liquids (such as the prepared beverage itself) from sticking to the chamber walls and remaining in the chamber even after the beverage is dispensed. The non-stick or not- wetting hydrophobic coating can be applied by the thermal spraying of a metal, ceramic, or polymer (for example, PTFE).

The hydrophobic non- wetting effect results when the contact angle of a liquid (i.e., the prepared beverage) with the surface of the chamber wall is greater than 90 degrees. If the contact angle is greater than 150 degrees, the surface is known as “superhydrophobic,” and droplets of liquid readily roll off of the chamber walls (an effect known as the “lotus effect,” named after the self-cleaning and superhydrophobic leaves of the lotus flower). In some embodiments of the invention, the chamber walls are superhydrophobic surfaces with a micro- or nano-scale topographical structure on the surfaces. The micro- or nano-graphic topological structure can be manufactured, for example, using a molding, etching, or engraving (including laser engraving) process. In some embodiments, the superhydrophobic surface is a superhydrophobic coating, such as a manganese oxide polystyrene nano-composite, a zinc oxide polystyrene nano-composite, a precipitated calcium carbonate, a carbon nano-tube coating, or a silica nano-coating.

In some embodiments of the invention, the self-cleaning chamber utilizes one or more cleaning devices to clean the chamber. The cleaning device can heat the chamber to kill microorganisms, flush the chamber with pressurized fluid, or sterilize the chamber. For example, in one preferred embodiment, the chamber is cleaned by a device that emits short- wavelength ultraviolet radiation to kill or inactivate microorganisms such as bacteria, viruses, and molds. In this embodiment of the invention, the cleaning device is a mercury-vapor lamp that emits UV radiation at biocidal wavelengths.

In another embodiment of the invention, the device for cleaning the chamber is a flushing device that maintains the fluid pressure in the beverage chamber at a steady level during the first 90% of the duration of the mixing and dispensing time of a beverage. However, during the final 10% of that duration, the flushing device raises the fluid pressure to a higher level. Once the beverage is fully dispensed, the flushing device raises the fluid pressure to an even higher level, ensuring that all liquid has been flushed from the chamber.

In some preferred embodiments of the invention, the chamber for preparing the beverage is coupled to the dispenser for dispensing the beverage, allowing the prepared beverage to flow from the chamber into the dispenser. In these embodiments of the invention, the dispenser for dispensing the beverage prepared by the appliance may be any of (for example) a spigot, a faucet, a tap, or a spout.

In some embodiments of the invention, after the beverage is prepared in the chamber, the beverage is immediately dispensed from the dispenser without any further actions being taken by the user. In other embodiments of the invention, however, the beverage is dispensed from the dispenser when the user takes an action that causes the appliance to dispense the beverage, such as pushing a button or pulling on a tap handle, or other methods known to those skilled in the art.

In some embodiments of the invention, the chamber for preparing a beverage is coupled to a mixing chamber, in which liquid from the at least one source of liquid is mixed with a concentrated beverage, and this mixture from the mixing chamber then flows into the chamber for preparing a beverage. In other embodiments of the invention, the liquid from the at least one source of liquid is mixed with a concentrated beverage inside the chamber for preparing a beverage.

In some embodiments of the invention, the liquid from the at least one source of liquid is water. The water can be carbonated or non-carbonated. In other embodiments of the invention, the liquid from the at least one source of liquid is a base liquid to which ingredients are added. The base liquid can be an alcohol or non-alcoholic liquid, a carbonated or non-carbonated liquid, or various combinations thereof. In some embodiments, an alcoholic liquid can be used as a base liquid, such as a beer (including ales and lagers), a cider, a wine, a malt-based beverage, a fermented beverage, a cider-based beverage, a spirit, and the like. In other embodiments, non-alcoholic versions of these various types of liquids can be used as a base liquid. The base liquid can also be a non-alcoholic liquid such as a beer, a juice, a syrup, a carbonated or non- carbonated flavored water, a carbonated or non-carbonated soft drink, a coffee, a tea, a milk, a plant extract, and the like.

In some embodiments of the invention, after the liquid from the at least one source of liquid is mixed with a concentrated beverage to prepare a beverage, the beverage is dispensed from the dispenser without further carbonation of the beverage. However, in certain other embodiments of the invention, the liquid from the at least one source of liquid is a still liquid, and after the still liquid is mixed with a concentrated beverage to prepare one or more servings of a beverage, the beverage is carbonated before dispensing the beverage from the dispenser. Similarly, in other embodiments of the invention, the liquid from the at least one source of liquid is a carbonated liquid, and after the carbonated liquid is mixed with a concentrated beverage to prepare one or more servings of a beverage, the beverage is further carbonated before dispensing the beverage from the dispenser.

In some embodiments of the invention, the concentrated beverage is delivered to the appliance in a container. The container holding the concentrated beverage can take many different forms: in various embodiments of the present invention, the container can be any one of a pod, a pack, a capsule, a bottle, a cylinder, a cartridge, or equivalents thereof. The container may be manufactured from plastics (including, but not limited to polyethylene terephthalate (PET) or high-density polyethylene), metals such as steel, stainless steel, or aluminum, or other materials such as glass, ceramic, composites, or other polymers.

Those of skill in the art will recognize that various beverages can be concentrated, pressurized, and packaged in the containers of the present invention. For example, the concentrated beverage of the present invention can be an alcoholic or non-alcoholic beer (including ales and lagers), a cider, a wine, a malt-based beverage, a fermented beverage, a cider-based beverage, a spirit, a juice, a syrup, a carbonated or non-carbonated soft drink, a coffee, or a tea.

In some preferred embodiments of the present invention, the chamber for preparing the beverage is divided into two portions—a first chamber and a second chamber—by a partition. In some of these embodiments of the invention, the partition is opaque, and the transparent viewing “window” is a wall of the second chamber. In these exemplary embodiments, the concentrated beverage and the liquid are mixed together in the first chamber to form a beverage, and that beverage then flows into the second chamber. The user is able to see the prepared beverage in the second chamber through the transparent viewing window, but the opaque partition or barrier blocks the user's view into the first chamber. In these embodiments, the partition may be punctured or torn when the beverage is finished mixing, allowing the beverage to flow into the second chamber, where the user of the appliance can view the prepared beverage.

In other embodiments of the invention, the chamber may comprise a third chamber portion, a fourth chamber portion, and so on, with additional partitions or barriers defining the boundaries of these chambers. For example, the third chamber could comprise a flavoring ingredient used to flavor the beverage after it is mixed in the first chamber, or a foaming agent used to create a desirable head of foam on a beer mixed in the first chamber. The beverage can flow into the third chamber after it is mixed in the first chamber, and then from the third chamber into the second chamber so that the user can view the prepared beverage before it is dispensed.

As discussed above, the chamber for preparing a beverage may be a disposable chamber. This disposable chamber may take many different shapes, such as a box, a cylinder, a or a sphere, and those of skill in the art will readily recognize that the disposable chamber could take other known three-dimensional shapes as well.

The disposable chamber may be manufactured from plastics (including, but not limited to polyethylene terephthalate (PET) or high-density polyethylene), metals such as steel, stainless steel, or aluminum, or other materials such as glass, ceramic, composites, or other polymers. The disposable chamber may be manufactured of a recyclable material, such as a recyclable plastic or aluminum, which allows the chamber to be recycled after it has been used to prepare a beverage.

In some preferred embodiments of the invention, this disposable chamber has an interior partition, as discussed above, that divides the chamber into first and second portions. The transparent portion of the exterior of the disposable chamber allows a user to view the interior of the second portion of the disposable chamber, while the opaque interior partition blocks the view into the first portion.

In some of these preferred embodiments of the invention, the first portion of the disposable chamber contains a concentrated beverage. The concentrated beverage may be in solid or liquid form, and can be carbonated or otherwise pressurized. Those of skill in the art will recognize that various beverages can be concentrated, pressurized, and packaged in the disposable beverage preparation chambers of the present invention. For example, the concentrated beverage of the present invention can be an alcoholic or non-alcoholic beer (including ales and lagers), a cider, a wine, a malt-based beverage, a fermented beverage, a cider-based beverage, a spirit, a juice, a syrup, a carbonated or non-carbonated soft drink, a coffee, or a tea.

In addition to the concentrated beverage itself, the disposable beverage preparation chamber may also contain pressurized gas. In embodiments of the invention, the gas is injected into the disposable chamber under pressure, and then the chamber is sealed. Various types of gases can be used to pressurize the concentrated beverages of the present invention, including but not limited to one or more of carbon dioxide, nitrogen, nitrogen dioxide, and nitrous oxide. In these embodiments, the pressurized gas dissolves into the concentrated beverage.

In addition to the portion of the disposable chamber that contains the concentrated beverage and the portion of the chamber with the transparent viewing window, the disposable preparation chamber may have additional portions containing one or more additional flavors or ingredients for a beverage. Examples of suitable flavor ingredients include (but are not limited to) a spice flavor, a fruit flavor, a hop flavor, a malt flavor, a nut flavor, a smoke flavor, other suitable flavors (such as a coffee flavor or a chocolate flavor), and mixtures of such flavors. The disposable beverage preparation chamber may also contain other solid or liquid concentrated ingredients, such as hop concentrates, fruit concentrates, sweeteners, bittering additives, concentrated spices, foaming promoters, concentrated malt-based liquids, concentrated fermented liquids, concentrated beer, colorants, flavoring additives, alcohols, and mixtures thereof.

In some embodiments of the invention, the disposable beverage preparation chamber contains enough concentrated beverage to prepare only a single serving of a beverage. Therefore, after: a) the disposable beverage preparation chamber is inserted into an appliance; b) the concentrated beverage inside is mixed with liquid; and c) the user of the appliance watches through the transparent window to see the beverage being prepared and dispensed, the disposable chamber is removed from the appliance and discarded or recycled.

In other embodiments of the invention, the disposable beverage preparation chamber contains enough concentrated beverage to prepare multiple servings of a beverage. In these embodiments, the disposable beverage chamber can be used, for example, to prepare a pitcher of beer—or, alternatively, could be reused multiple times to prepare and dispense several glasses of beer before it is removed and replaced with a new disposable preparation chamber. In various embodiments of the invention, the disposable beverage preparation chamber may vary in size. The size of the disposable beverage preparation chamber may depend on, for example, the type of concentrated beverage contained in the chamber, or the number of servings of a beverage to be prepared from the concentrated beverage contained in the chamber.

In some embodiments of the invention, at least one portion of the exterior casing of the disposable beverage preparation chamber is permeable, allowing liquid to enter the chamber to mix with the concentrated beverage contained inside, and/or allowing the prepared beverage to exit the chamber and be dispensed. In other embodiments of the invention, the exterior casing of the beverage chamber is not permeable, and must be punctured to allow liquid to enter the chamber to mix with the concentrated beverage contained inside and/or to allow the prepared beverage to exit the disposable container and be dispensed. In embodiments where the disposable chamber contains an interior barrier or partition, the partition may be permeable (for example, a very fine grid of material that appears opaque to the human eye but that allows liquid to flow through the grid), or may be punctured/torn to allow the prepared beverage to flow inside the container.

In some preferred embodiments of the invention, the exterior casing of the disposable chamber protects the concentrated beverage contained inside by preventing exterior light from entering the chamber, as well as preventing oxygen and other gases from entering the chamber.

As known to those of skill in the art, light can cause chemical reactions with the concentrated beverage contained in the disposal chamber, and by resisting the transmission of light into the chamber, the exterior casing of the chamber can protect and preserve the flavor of the beverage. For example, ultraviolet light at wavelengths from 200 nanometers to 400 nanometers (and, in particular, 280 nanometers to 340 nanometers) degrades iso-alpha acids in hops, a component of beer, as does visible blue light (wavelengths of 340 nanometers to 500 nanometers) in the presence of riboflavin, which is naturally present in beer. As such, in preferred embodiments of the invention, the exterior casing of the disposable chamber blocks light with wavelengths below 500 nanometers from entering the chamber. For example, the exterior casing may be coated with a light blocking colorant, which prevents light from being transmitted into the chamber.

To prevent light from entering through the transparent window in the casing of the chamber, the window can be covered with a removable opaque material, such as a film or a foil, that covers the transparent portion of the chamber, and that can be peeled away or otherwise removed when the chamber is used to prepare a beverage. The film or foil can be composed of materials known to those of skill in the art, such as aluminum foil, and may be covered with the same light-resistant coating as the casing of the chamber itself. Like the disposable chamber, the removable film/foil may be recyclable as well.

Similarly, as known to those of skill in the art, oxygen and other gases can also react with the concentrated beverage (in particular, concentrated beer), which can negatively affect the flavor of the beverage. To prevent oxygen and other gases from entering the chamber, the exterior casing of the chamber may be impermeable to oxygen or other gases. For example, the exterior of the disposable chamber may be coated with ethylene vinyl alcohol (EVOH), nylon, aluminum, or another inorganic oxide which prevents oxygen from seeping into the chamber.

In some embodiments of the invention, the disposable chamber contains an oxygen scavenger which actively consumes oxygen in the chamber and prevents it from reacting with the concentrated beverage and/or other flavors and ingredients in the chamber. In various embodiments of the invention, the oxygen scavenger may be a sulfite or sulfonic acid, an iron complex, a cobalt complex, ferrous carbonate, ascorbate, sodium hydrogen carbonate, or an oxygen- scavenging polymer. In certain embodiments of the invention, the oxygen scavenger is a polyester composition composed of a blend of thermoplastic polyester (such as polyethylene terephthalate, polyethylene naphthalene), a cobalt salt (such as colbalt stearate, cobalt neo-deconoate), ethylene glycol, and pyromellitic dianhydride. In these embodiments, the cobalt salt actively promotes the oxidation of the polyester composition, causing the composition to behave as an active oxygen scavenger.

In embodiments where at least a portion of the exterior casing of the disposable chamber is permeable, these one or more permeable portions of the casing can similarly be covered with a removable film or foil to help prevent light and/or gases from entering the disposable chamber and reacting with the beverage ingredient(s) contained within.

### EXAMPLES

The following prophetic examples describe potential embodiments of the present invention:

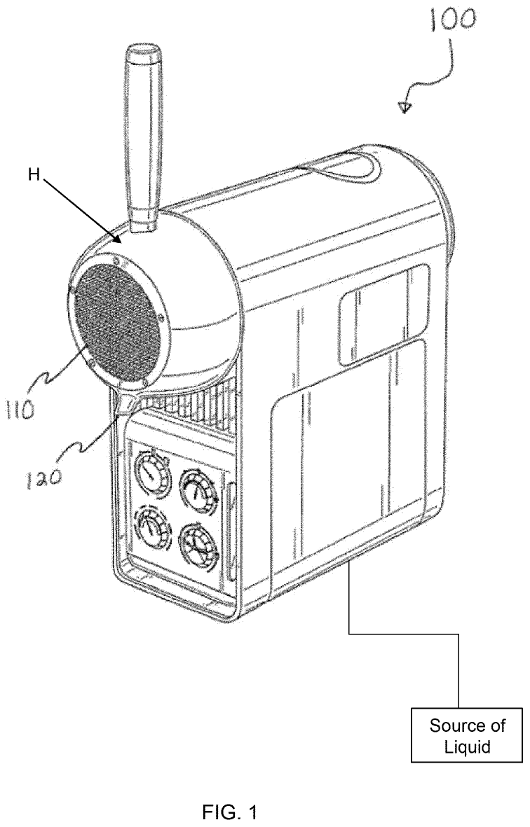

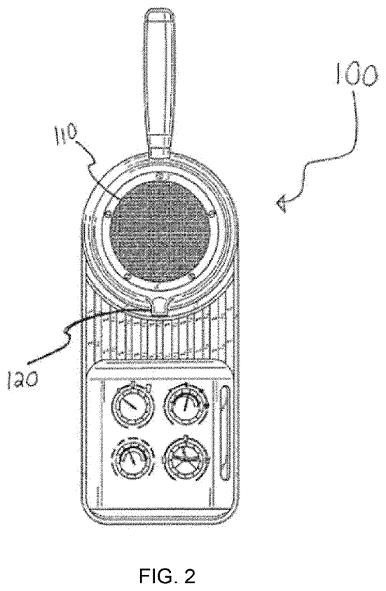

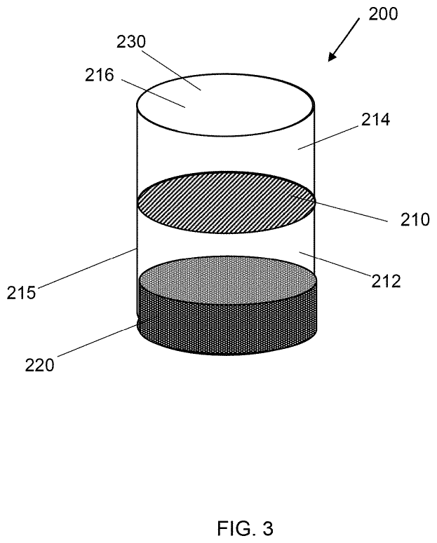

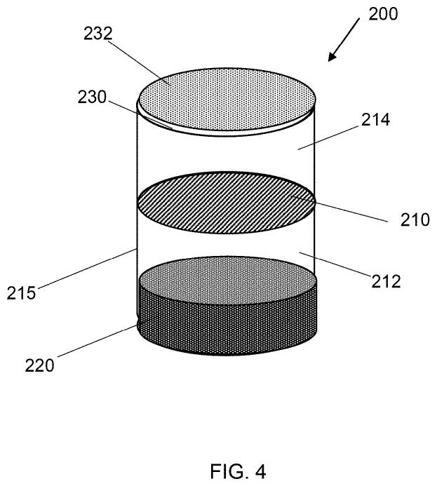

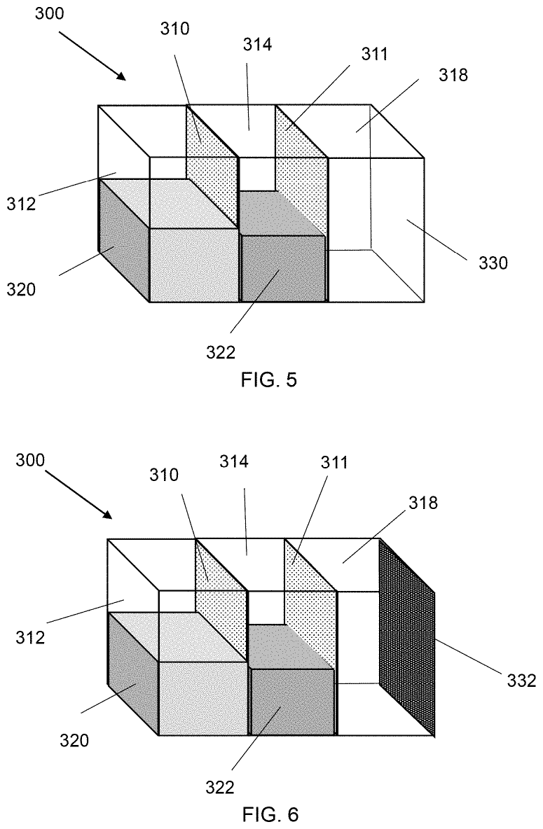

Example 1: FIG. 1 and FIG. 2 illustrate an exemplary appliance 100 for preparing a beverage. In this exemplary embodiment, the appliance 100 has a circular viewing window 110 positioned in the front of appliance 100, which allows a user to see a beverage being prepared inside the appliance 100 before the beverage is dispensed from dispenser 120. The circular viewing window 110 is a wall of a chamber for preparing a beverage located inside the appliance 100, and the window 110 allows a user to view inside that chamber to watch the beverage being prepared.

Example 2: A recyclable cylindrical pod 200 for preparing a beverage. The recyclable pod 200 is composed of recyclable plastic, and features an opaque plastic partition 210 that divides the interior of the pod into two separate compartments 212, 214. The first chamber 212 contains a concentrated, carbonated, high-gravity beer 220. The recyclable pod 200 is inserted into an appliance 100 for preparing a beverage, and a wall 215 of the first chamber 212 is punctured, allowing carbonated water to enter the first chamber 212 and mix with the concentrated beer, resulting in a drinkable beer being produced. The partition 210 between the first chamber 212 and the second chamber 214 is then punctured, allowing the beer to flow into the second chamber 214. One of the exterior circular walls 216 of the second chamber 214 is composed of transparent plastic, allowing a user to see the prepared beer flowing into the second chamber through the window 230 formed by the transparent plastic. The transparent plastic window 230 is covered by aluminum foil 232, which can be peeled away when the pod 200 is used to allow a user to see inside the chamber 214. The beverage is then dispensed from the second chamber 214 and the appliance 100.

Example 3: A recyclable box-shaped capsule 300 for preparing a beverage. The recyclable capsule is composed of recyclable aluminum, and features two opaque aluminum partitions 310, 311 (the partitions comprising a fine grid that appears opaque but that is permeable to liquid) that divide the interior of the capsule into three separate compartments 312, 314, 318. The first chamber 312 contains a concentrated beer 320, the second chamber 314 contains one or more flavoring ingredients 322 for the beer, and the third chamber 318 features a transparent plastic window 330 as one of its walls, allowing a user of the capsule to view inside the third chamber 318 as a beer is being prepared. The transparent rectangular window 330 is covered with recyclable plastic film 332, which can be peeled off of the window to allow a user to view inside the third chamber 318 as a beverage is being prepared in the recyclable capsule. The capsule 300 contains enough concentrated beer to provide multiple servings of beer when the concentrated beer is mixed with carbonated water.

Embodiments and prophetic examples of the present invention have been described for the purpose of illustration. Persons skilled in the art will recognize from this description that the described embodiments and prophetic examples are not limiting, and may be practiced with modifications and alterations limited only by the spirit and scope of the appended claims which are intended to cover such modifications and alterations, so as to afford broad protection to the various embodiments of the invention and their equivalents.

1. An appliance for preparing a beverage, comprising:
a housing;
at least one source of liquid;
a chamber for preparing the beverage,
wherein the chamber is a disposable container comprising an exterior casing, and a first chamber and a second chamber,
wherein the first chamber comprises a concentrated beverage, and the first and second chambers are divided by an opaque partition,
and wherein the exterior casing is adapted to resist the transmission of light into the disposable container;
a dispenser for dispensing the prepared beverage,
wherein at least one portion of the exterior of the appliance is transparent, and the at least one transparent portion of the exterior of the appliance comprises a transparent wall of the chamber for preparing the beverage,
wherein the liquid and the concentrated beverage are mixed in the first chamber, and the transparent portion is a transparent wall of the second chamber, and
wherein the at least one source of liquid is a carbonated liquid.

2. The appliance of claim 1, wherein the transparent portion is rectangular.

3. The appliance of claim 1, wherein the transparent portion is circular.

4. The appliance of claim 1, wherein the chamber for preparing the beverage is coupled to the dispenser for dispensing the liquid beverage.

5. The appliance of claim 1, wherein the chamber for preparing the beverage and the dispenser are orientated on a single face of the appliance.

6. The appliance of claim 1, wherein the chamber for preparing the beverage is a disposable chamber that can be removed from the appliance and replaced with a new disposable chamber.

7. The appliance of claim 1, wherein the concentrated beverage is a solid or liquid concentrated beverage.

8. The appliance of claim 1, wherein the transparent wall is comprised of a material selected from the group consisting of glass, plastics, and polymers.

9. The appliance of claim 1, wherein the chamber for preparing the beverage further comprises a removable opaque material that covers the transparent wall of the second chamber.

10. The appliance of claim 9, wherein the removable opaque material is a film or a foil.
